(19) United States
(12) Patent Application Publication
(10) Pub. No.: US 2009/0296685 A1
(43) Pub. Date: Dec. 3, 2009

(54) User-Mode Prototypes in Kernel-Mode Protocol Stacks

(75) Inventors: Gregory O'Shea, Cambridge (GB); Dinan Gunawardena, Cambridge (GB)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/129,119

(22) Filed: May 29, 2008

(51) Int. Cl. H04L 12/28

(52) U.S. Cl. 370/351

(57) ABSTRACT

Methods of enabling user-mode prototypes in kernel-mode protocol stacks are described. A protocol stack comprises a set of kernel-mode modules. The protocol stack defines a data path for packets. At least one interception point is defined in a kernel-mode module at which a packet can be intercepted and/or inserted. In an embodiment, each packet intercepted at the interception point, or a copy of said packet, is sent to a user-mode module. The user-mode module processes the packet in some way and then returns the packet to the same, or a different, interception point in the data path. In this way, a user-mode module (which is easier to program) can be used to prototype functionality of a kernel-mode module without requiring kernel-mode code to be written.

### BACKGROUND

Before a research idea can gain widespread acceptance it must be shown to work in practice, yielding sufficient benefit to outweigh its deployment and maintenance costs, without impairing the existing infrastructure. Demonstrating this in a convincing manner often requires a working prototype. In the context of computer-implemented methods, such as new networking technologies, building the prototype requires developing new, or modifying existing, kernel-mode modules. A kernel-mode module is a module which forms part of an operating system of a computing device. A problem for many researchers is that the kernel-mode programming environment is unfamiliar and notoriously hard to master. As a result, many research initiatives are delayed, or blocked, when a prototype is required but staff with the required skills are not available to develop a kernel-mode module.

The embodiments described below are not limited to implementations which solve any or all of the disadvantages of known prototyping methods.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Methods of enabling user-mode prototypes in kernel-mode protocol stacks are described. A protocol stack comprises a set of kernel-mode modules. The protocol stack defines a data path for packets. At least one interception point is defined in a kernel-mode module at which a packet can be intercepted and/or inserted. In an embodiment, each packet intercepted at the interception point, or a copy of said packet, is sent to a user-mode module. The user-mode module processes the packet in some way and then returns the packet to the same, or a different, interception point in the data path. In this way, a user-mode module (which is easier to program) can be used to prototype functionality of a kernel-mode module without requiring kernel-mode code to be written.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a system comprising user-mode modules and kernel-mode modules;

FIG. 2 shows the positioning of interception points within a set of kernel-mode modules;

FIG. 3 is a schematic diagram of an embodiment of a system comprising user-mode modules and kernel-mode modules where a user-mode module uses an API layered on to a socket;

FIG. 4 shows functional units at a kernel-mode module hosting an interception point;

FIG. 5 shows packet formats;

FIG. 6 is a flow diagram of a packet inspection/insertion method performed at a kernel-mode module hosting an interception point;

FIG. 7 is a flow diagram of a packet forwarding method performed at a kernel-mode module hosting an interception point; and

FIG. 8 illustrates an exemplary computing-based device in which embodiments of the methods described herein may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a system which uses TCP/IP, the system described is provided as an example and not a limitation. As those skilled in the art will appreciate, the present examples are suitable for application in a variety of different types of systems which use different frame types. Furthermore, the examples below use IPv6 address formats by way of example only. The methods described are also applicable to other address formats and types, e.g. IPv4.

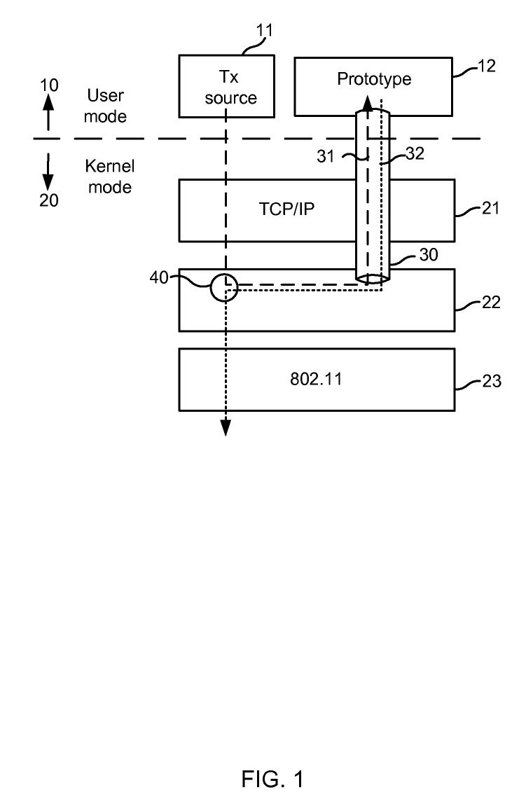

FIG. 1 is a schematic diagram of a system comprising a set of modules which can be executed by a computer. The set of modules is divided into two sub-sets: user-mode modules 10 and kernel-mode modules 20. Two user-mode modules 11, 12 and three kernel-mode modules 21-23 are shown in FIG. 1. It will be appreciated that a system may comprise different numbers of user-mode and/or kernel-mode modules.

Kernel-mode refers to a mode of operation of a computer in which the software program presently being executed is permitted to execute the full instruction set of the processor, access all parts of the computer's memory and interact directly with hardware devices attached to a computer. Kernel-mode is typically restricted to software modules that form part of the operating system of a general-purpose computer. Failures of a kernel-mode process can result in the operating system crashing and/or corrupt memory for other processes.

User-mode refers to a mode of operation in which the software program presently being executed is not permitted to execute a subset of instructions deemed privileged in the design of the computer's Central Processing Unit (CPU), may only access a subset of the computer's memory that has been specifically allocated to the program, and may only access other parts of memory and attached hardware devices through the mediation of kernel-mode software typically running as part of the operating system. As a user-mode process has process separation between it and other user-mode processes enforced by the operating system, if a user-mode process fails (or crashes), this does not, in general, crash other user-mode or operating system processes. A user-mode module is typically written at a higher-level than that of the kernel-mode modules.

A Tx source module 11 generates packets which require processing by the kernel-mode modules. The Tx source may comprise, or receive an input from, a browser application, messaging application or any other application which generates data for transmission or processing. Whilst this Tx source module 11 is shown as a user-mode module in FIG. 1, in other examples the Tx source module may be a kernel-mode module.

A prototype module 12 can implement some prototype functionality which a developer wishes to test. The prototype module may be written in a strongly-typed programming language, using a preferred IDE and fully functional class libraries. In an example, the prototype module may be a modified or a new protocol driver. The prototype module may be co-located within the same operating environment as the process being intercepted or alternatively the prototype module may be on a different machine in a network or on another virtual machine.

The set of kernel-mode modules 21, 22, 23 form a protocol stack for processing packets. In use, packets are processed by each of the set of kernel-mode modules 21-23 in that order (i.e. 21→22→23). With the addition of a prototype module 12 the processing chain may change (e.g. to 21→22→12→22→23) and this is described in more detail below.

For the purposes of example only, the prototype is described as providing a driver for a L2.5 protocol which allows the host device to participate in a wireless mesh network, such as a Virtual Ring Routing (VRR) driver (e.g. as described in a paper by M. Caesar, M. Castro, E. Nightingale, G. O’Shea, and A. Rowstron entitled ‘Virtual Ring Routing: Network routing inspired by DHTs’ and presented at Sigcomm'06). The methods described herein may be used for writing protocols other than a L2.5 protocol and interception points may be placed at any point in the kernel-mode protocol stack where there is a defined interface between modules in the stack, i.e. between defined transmit and receive points within any existing protocol module in the stack e.g. around the TCP driver. In another example, an interception point (or multiple points) might be built into the TCP/IP driver (e.g. as part of a firewall hook).

In such an example implementation, module 21 implements a Layer 3 TCP/IP protocol, module 22 implements a Layer 2.5 mesh protocol and module 23 implements a Layer 2 wireless interface protocol (e.g. IEEE 802.11, WiFi). Prototype modules can implement code which adapts the operation of the Layer 2.5 module 22, without requiring a programmer to modify, or significantly modify, the code of module 22. It should be understood that the particular functions of the kernel-mode modules 21-23 and user-mode module 12 are only examples of the functions which these modules could perform and that any of the modules could perform a different function to that described here. For example, the kernel-mode modules 21-23 may form any data processing chain where these is a programming interface between modules (such that it is possible to fully describe a piece of data being passed from one processing unit (say a function or procedure) in the processing chain and the next). In an example, the prototype module may be used in developing protocol test suites, implementing firewalls or network monitoring.

At least one interception point 40 is added within the kernel-mode protocol stack 20. The interception point 40 has a function of redirecting the flow of certain packets to one or more user-mode modules 12 running outside of the protocol stack 20. Intercepted packets are forwarded between the interception point 40 and the user-mode module 12 via a tunneled path 30. The packet tunneling within the stack may use UDP or TCP and in the following description UDP is described by way of example only. The user-mode module 12 is arranged to receive packets extracted by the interception point 40 in the protocol stack and decides how the intercepted packets should be processed. One operation of the interception point 40 is for the interception point 40 to supply a received packet to the user-mode module 12, with or without making a copy of the packet, without disturbing the flow of the original packet through the protocol stack. This will be referred to as a “peek” operation. Another operation of the interception point 40 is for the interception point 40 to supply a received packet, with or without making a copy of the packet, to the user-mode module 12 and to remove the original packet from the protocol stack. This will be referred to as a “steal” operation. FIG. 1 shows a simple example with a single interception point 40 and a single user-mode module 12. There can be multiple interception points 40 at different positions within the protocol stack and/or multiple user-mode modules 12 which operate on the intercepted packets. One embodiment positions interception points 40 at each side of a kernel-mode module that it is desired to prototype. Another embodiment positions interception points internal to a kernel-mode module that is otherwise monolithic. For example the TCPIP.SYS driver in Windows implements TCP, UDP and IP functionality and interception points may be inserted to enable a prototype module to be inserted in the processing flow between the TCP and IP functionality in this model.

The use of interception points, as described herein, enables prototypes to be written as a user-mode module (e.g. in a higher-level language etc) but still to be implemented on the real operating system, rather than a dummy operating system implemented in user-mode. The interception point placed above a kernel-mode module may be referred to as TxHi on the Tx path (e.g. interception points 41, 45) and RxHi on the Rx path (e.g. interception points 43, 47). Similarly, the interception point placed below a kernel-mode module may be referred to as TxLo on the Tx path (e.g. interception points 42, 46) and RxLo on the Rx path (e.g. interception points 44, 48). Other naming conventions may alternatively be used (e.g. such that Lo/Hi and Tx/Rx are viewed from the point of view of the shim).

Possible actions of the user-mode module 12 include: inspection of a packet; deletion of a packet; reinsertion of the packet unmodified into the protocol stack at the point at which it was diverted; reinsertion of the packet unmodified at some other point in the protocol stack; reinsertion (at the same insertion point 40 or at a different insertion point 40) after the packet has been modified by the user-mode module 12 in some way. Reinsertion need not be synchronous with respect to packet extraction and may occur after some intentional processing delay. The user-mode module 12 can also create a new packet for insertion into the data flow by an interception point 40. This new packet is not a modified form of an intercepted packet, but a packet which is generated at a time determined by the user-mode module 12 and having a form (i.e. address information, payload) determined by the user-mode module 12.

The intercepted packets are forwarded 31 between an interception point 40 and a user-mode module 12 that has registered itself with the interception point 40. The user-mode module may return the packets 32, with or without modification, and/or it may insert new packets 32 to the interception point 40. These primitives enable the user-mode module 12 to rewrite the stream of packets flowing between kernel-mode modules. This can allow the behavior of a protocol driver to be altered, or prototyped, without the need to modify the code of the kernel-mode driver itself, or so that an entirely new protocol can be layered between existing protocol drivers without the need to write any kernel-mode code at all. The modified behavior may be the external behavior of the module or the internal behavior (e.g. as in the TCPIP.SYS example described above).

Each interception point is distinguished among the set of interception points, for example by associating a distinct set of IPv6 addresses with each interception point. In an embodiment of the invention there are four IPv6 addresses associated with each interception point: one IPv6 address is common to all interception points 40 and may be used to identify any or all of them; a second IPv6 address is unique to a specific interception point 40 and is used for redirecting packets to or from the transmit path of the protocol stack; a third IPv6 address is unique to a specific interception point 40 and is used for redirecting packets to or from the receive path of the protocol stack; a fourth IPv6 address is unique to a specific interception point 40 and is used as a control channel between a user-mode component and the interception point, for example to register the user-mode component with the interception point. In this embodiment of the invention, the user-mode component may use a UDP socket for communication with the interception point and sequence numbers for packets being redirected between the interception point and the user-mode component may be encoded as a UDP port number associated with the interception point; in other words the sequence number is encoded in the destination UDP port number when the user-mode component sends to the interception point, and the sequence number is the source UDP port number when the interception point sends to the user-mode component. In this arrangement the control information, such as the identity of an interception point and sequence number, are not visible in the data presented to the user-mode module.

In an alternative embodiment of the invention, control information is embedded within the data exchanged between the interception point and a user-mode component, for example as a small amount of overhead information added to each redirected packet. The overhead information may be added as a control block or header and in some cases, the packet may be modified in a deterministic way. The control block associated with the packet that allows the kernel-mode code in the shim layer to determine the target within kernel-mode for the injected packet. The packet with the overhead information is then sent to the user-mode prototype using any suitable communication channel. In a first example a UDPv6 packet may be sent over the standard IPv6 stack to encapsulate the Ethernet frame and in a second example a memory buffer may be used and the packet may be sent to the user-mode prototype over an IOCTL style interface.

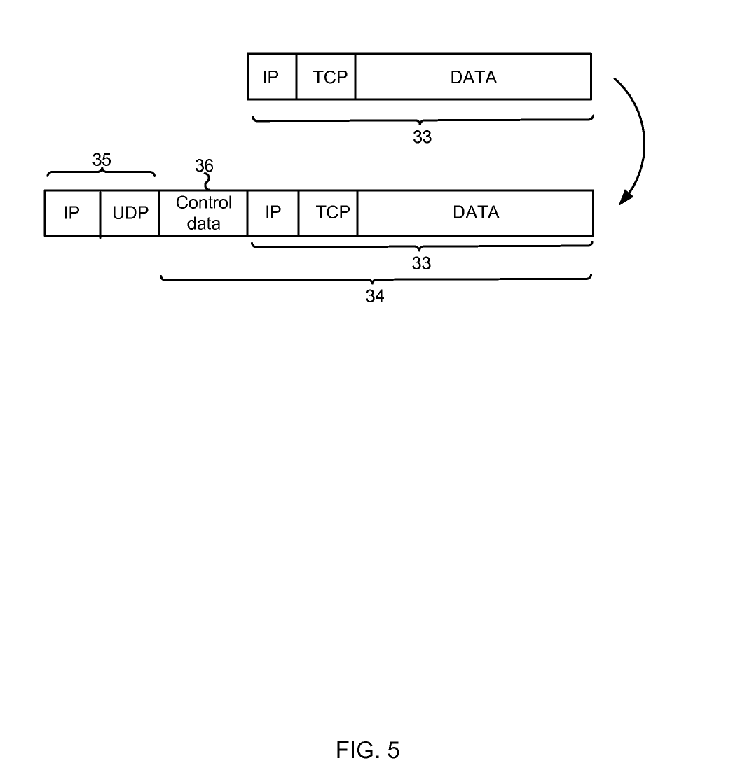

In an example, the overhead information includes an index number to indicate which of several possible interception points 40 was involved, a sequence number and, when required, an index number to disambiguate between several possible hardware devices adjacent to the interception point on the packet transmit or receive paths of the protocol stack. The overhead information is shown in FIG. 5 (control data 36). The overhead information is inserted by the interception point, immediately ahead of a redirected packet, in the case of a packet being sent from an interception point to a user-mode component. The overhead information is inserted by the user-mode component 15, immediately ahead of a redirected packet, in the case of a packet being sent from a user-mode component to an interception point. For example, the overhead information can help to ensure correct and complete ordering of the packets. Overhead information can also help in switching disambiguating between multiplexed interception points in a driver that is multi-homed over several underlying devices.

A user-mode module 12 registering with an interception point 40 may indicate that it wishes only to inspect the packet stream (the peek operation described above), in which case the packets continue to be processed by the existing kernel mode drivers. The user-mode application can alternatively exert total control over packets at the interception point, in which case the packets are removed from the operating system (the steal operation described above). The packets may be removed instantly or the packets may be buffered for a period of time pending the user mode prototype being scheduled. Additional filters may be specified detailing the types of packets to be intercepted (in a peek or steal operation), e.g. using a bit-mask or based on source subnet, and these additional filters may be based on the process or the thread ID originating the packet.

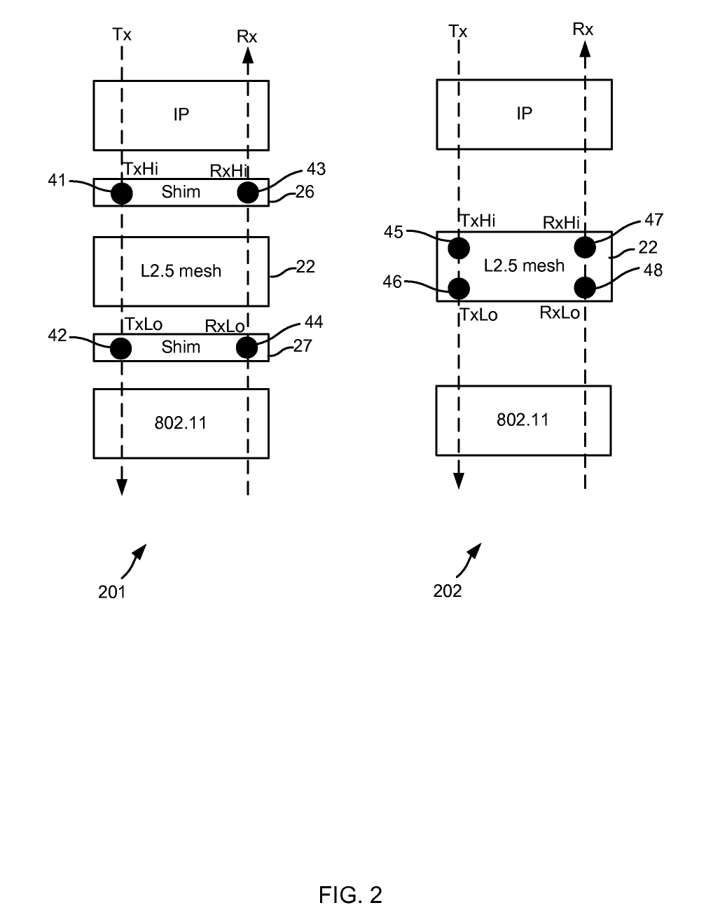

Aspects of the overall system shown in FIG. 1 will now be described in more detail. A first example 201 in FIG. 2 shows that the interception points 40 may be implemented as part of additional drivers 26, 27, called ‘shims’, placed between existing drivers. This is useful where the existing drivers cannot be modified. Each new driver 26 incorporates code for an interception point on the packet transmit (Tx) path 41 and an interception point on the packet receive (Rx) path 43. New driver 27 incorporates code for an interception point 42 and an interception point 44. A second example 201 in FIG. 2 shows that the interception points 40 can be integrated into an existing driver, such as at either or both of the upper and lower edges of a module that can be modified. Existing driver 22 is modified to incorporate code for interception points 45-48. The term “host driver” will be used to refer to any module in the protocol stack that includes an interception point. Although a shim is shown as supporting two interception points, it may support only one interception point (e.g. just in the transmit path) or it may support a higher number of interception points.

Both the examples 201 and 202 in FIG. 2 show a transmit path Tx through the protocol stack and a receive path Rx through the protocol stack. The transmit path has two interception points 41, 42 (45, 46) positioned on each side of module 22. Similarly, the receive path has two interception points 43, 44 (47, 48) positioned on each side of module 22. One option for using the arrangement shown in FIG. 2 will now be described. A packet is received by the upstream interception point 41. The intercepted packet is removed from the transmit path and forwarded to the user-mode module 12 via a tunneled path (30, FIG. 1). At the user-mode module 12, the packet is monitored or modified by the user-mode module 12 and then returned, via a tunneled path, to the downstream interception point 42. A similar process occurs on the receive path Rx. A packet is received by the upstream interception point 44. The intercepted packet is removed from the receive path and forwarded to the user-mode module 12 via a tunneled path (30, FIG. 1). At the user-mode module 12, the packet is monitored or modified by the user-mode module 12 and then returned, via a tunneled path, to the downstream interception point 43. In this way, the operation of the kernel-mode module 22 can be adapted (prototyped) by the user-mode module 12. In other examples, the packet may be copied and not removed from the transmit path and/or the packet may not be returned to the path.

A user-mode module 12 can be programmed directly onto a socket 25. Another embodiment uses an accessible API for a network programmer of modest experience, such that the prototype comprises a user-mode program written in a high-level language, which sends and receives packets over the API. The API functions as an abstraction layer, so that the mechanisms used to support and control redirection of packets between the user-mode component and interception point need not impinge upon the packet data that are manipulated by a prototype. The API is responsible for obtaining UDP sockets for communicating with an interception point, registering with an interception point, setting and checking sequence numbers for packets redirected to or from an interception point, serializing the delivery of packets to and from an interception point in order to avoid concurrency in the prototype, performing reordering of packets that arrive out of sequence having been redirected by an interception point, matching control requests generated in the API with a timely response from the relevant interception point, maintaining an abstract view of the state of an interception point for inspection by the prototype.

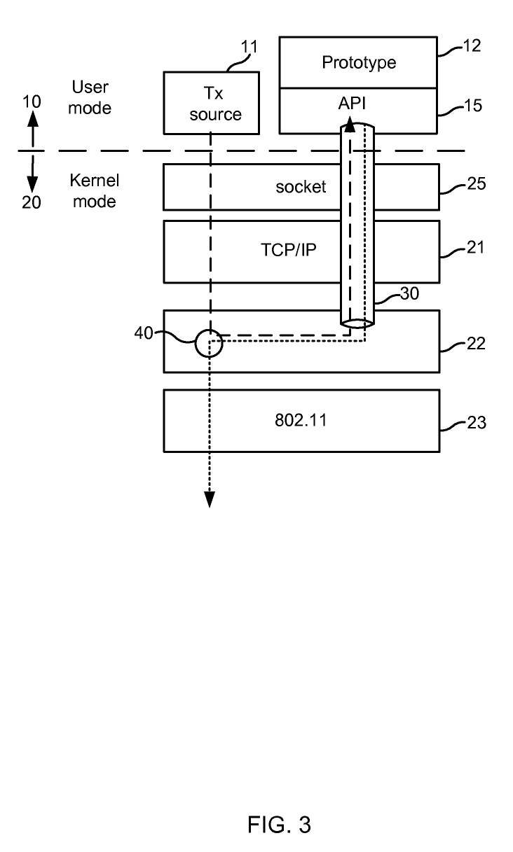

FIG. 3 shows an embodiment in which the socket API 15 is used as the basic interface against which applications 12 are programmed. Any communication pipe that allows data to be transferred between a user-mode process and a kernel-mode driver may be used. For example any kernel-to-user-mode tunnel interface could be used, such as input/output control (IOCTL), ReadFile/WriteFile, RPC/Named Pipe etc. In other embodiments the use of a socket may be replaced by some other form of programming interface, such as a file handle, subject to the introduction of alternate addressing information and control messages. In an example which uses raw sockets, the user-mode side comprises a standard Windows socket and the kernel-mode may use a NDIS interface. In an example using the IOCTL interface, the user-mode interface is the user-mode device driver IOCTL interface and the kernel-mode interface is the OS specific IOCTL interface.

When dealing with multiple interception points 40 the programmer can choose to use a separate socket 25 for communication with each interception point 40 or communication with multiple interception points 40 can be multiplexed over a single socket 25. When an application registers with an interception point, a UDP socket 25 comprising a valid link-local IPv6 address and a port number is registered with the interception point 40. Registration is performed by sending a UDP packet towards a link-local IPv6 address associated with an interception point, from which the interception point is able to recover the IPv6 address and UDP port used by the socket from information in the UDP header within the packet. Conventionally, the socket API 15 is primarily intended to provide the programmer with access to the payload of a packet, i.e. a strict subset of the whole contents of a packet, excluding protocol data such as IP and TCP headers. In an embodiment the data that is tunneled between the interception point 40 and socket 25 represents an entire packet, inclusive of its IP and Ethernet headers. These packets are then encapsulated within an additional pair of IP and UDP headers whose destination is either a reserved address recognized by an interception point, in the case of packets sent from a user-mode component to an interception point, or the address of a registered socket, in the case of a packet sent from an interception point to a user-mode component. In either case, the existing IP forward mechanisms are used to deliver the packet accordingly.

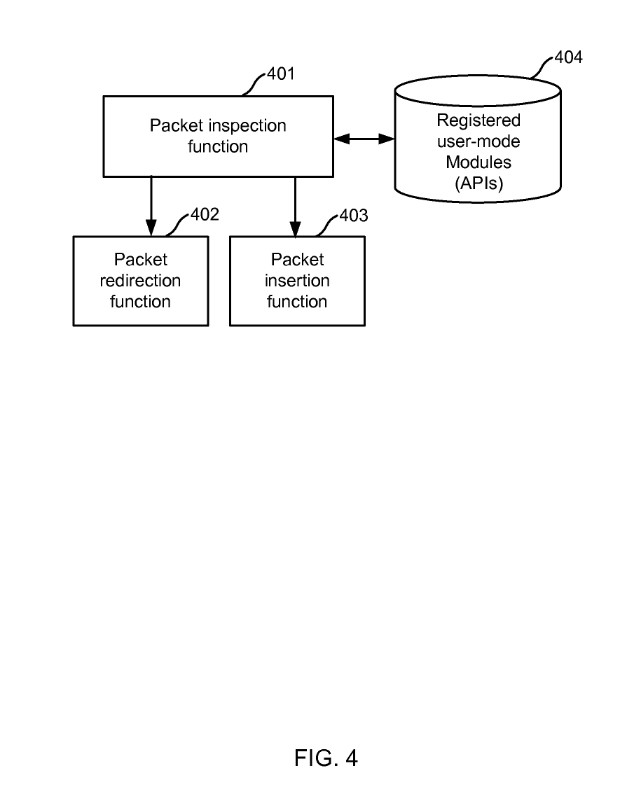

FIG. 4 shows the main functional units of a driver hosting an interception point. Each host driver is identified by one or more unique IPv6 link-local addresses. As described above, one IPv6 address plus overhead information may be used or several addresses per driver may be used (e.g. a distinct address may be used for discovery of interception points, and for Tx, Rx, Control). A packet inspection function 401 inspects packets on the data path, or paths, passing through the driver and filters out and processes any UDP packets whose destination address is that associated with the host driver. This allows the driver to identify new, or modified, packets that a user-mode module 12 wishes to insert into the data path.

On the packet receive path (43, 44, 47, 48, FIG. 2) the interception point decides whether the packet should be redirected to one or more user-mode components that have registered to receive packets on the receive path, in which case all packets are so forwarded. On the packet transmit path (41, 42, 45, 46, FIG. 2) there are four cases for the interception point to consider: first, it detects and handles tunneled packets originating from a user-mode component that is reinserting a packet into the transmit path; second, it detects and handles tunneled packets originating with a user-mode component that is reinserting a packet into the receive path; third, it detects, handles and replies to control packets originating with a user-mode component that wishes to interact (e.g. register or query) with the interception point; fourth, if none of the preceding apply, it decides whether the packet should be redirected to one or more user-mode components that have registered to receive packets on the transmit path, in which case all packets are so forwarded.

A packet insertion function 403 inserts packets into the data path through the driver. Packets that are coming down from a user-mode module are stripped of any control data (e.g. a control header) before insertion. A store 404 stores information about which user-mode modules 12 are interested in packets received at that interception point. The information can comprise registrations by instances of the user-mode API. The interception point has functionality 402 to redirect packets by forming a tunnel 30 (e.g. an IPv6 UDP packet tunnel) to a registered API 15. The functions shown here do not need to incur significant additional processing overhead above that of the host driver, in particular the interception point may avoid expensive memory copy operations through manipulation of the original packet, pre-pending UDP tunnel headers to the packet when redirecting to a user-mode component, and skipping past the UDP tunnel headers when receiving a packet redirected from a user-mode component.

FIG. 5 shows the conventional format of a packet 33 at a point below the TCP/IP stack, such as at any of the interception points 41, 43, 45, 47 shown in FIG. 2. The packet 33 comprises a payload of data and TCP and IP headers and in some examples a data frame may be fragmented into multiple packets. FIG. 5 also shows the format of a packet which has been encapsulated for transport over tunneled path 30, wherein a UDP tunnel header comprising an IPv6 header and a UDP header (or a TCP tunnel header comprising an IPv6 header and a TCP header) has been attached either by the interception point, in the case of a packet redirected from an interception point to a user-mode component, or by the socket layer of the conventional protocol stack when a user-mode component sends data over its chosen UDP socket towards an interception point. The payload 34 of the encapsulated packet comprises a packet 33 having the conventional format of a packet at the interception point 40 of the protocol stack, including appropriate headers (in this case TCP and IP headers). When no alternative path for control information is available, payload 34 may also comprise additional control information 36 (also referred to as overhead information) as described above. The header may be implemented using a wrapper to create a 7 byte offset or there may be an area of reserved bytes for this header. Alternatively the header may be of any size and internal structure and may, in some examples, not be contiguous in physical memory layout with respect to the packet being intercepted. In the case of a prototype implementing a newly defined protocol, then any additional headers required by the new protocol may be inserted ahead of the original IP header (in 33). The encapsulated packet has an outer header 35 which will either indicate the destination driver (in the case of the API-driver communication direction) or the API (in the case of the driver-API communication direction). This outer header 35 may comprise an IP address, a protocol identifier (e.g. TCP or UDP) and a socket ID (or port number).

As described above, the overhead information which is contained within the control data 36 may alternatively be conveyed in a different manner (and therefore control data 36 may be omitted). In an example, different IP addresses (e.g. different IPv6 addresses) may be used to distinguish between interception points. In such an example, different addresses may be used for the interception point on the transmit and receive paths, for control data and also for discovery of interception points. This can be described with reference to the first example 201 in FIG. 2 (although it may also be applied to the arrangement shown in the second example 202). In this example 201 different IP addresses may be allocated to each of:
Interception point 41 in Tx path of upper shim
Interception point 42 in Tx path of lower shim
Interception point 43 in Rx path of upper shim
Interception point 44 in Rx path of lower shim
Upper shim 26 for control data
Lower shim 27 for control data
Discovery of shims within the stack and the addresses associated with each shim (e.g. the Tx address, Rx address and control address)—for example, on receipt of a message addressed to this particular IP address, each shim (or driver, where the interception points are embedded within a driver) may reply with a message containing all the relevant addresses.
   Additionally, in some examples, sequence numbers may be included within the addresses as port numbers, with such port numbers being used in both traffic from an interception point to a user-mode module and traffic from a user-mode module to an interception point.

In another example, the control information may not be included within a control data element 36 (and therefore control data 36 is omitted) but instead the information may be provided within socket options and this information may be transmitted through the stack along with the packet. In other examples, any suitable control channel may be used to signal the control information instead of including it within the packet (e.g. as control data 36).

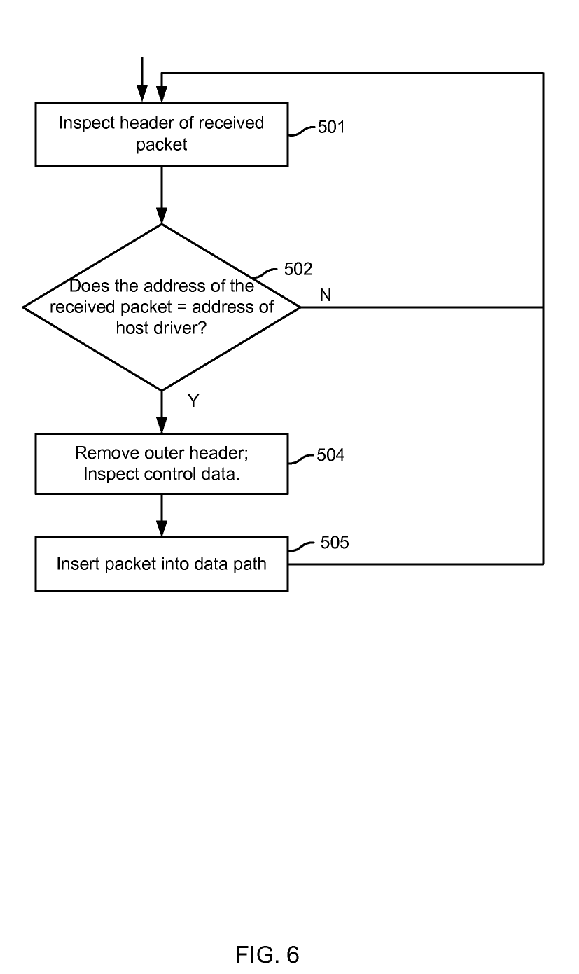

Data paths between the kernel-mode interception point 40 and the user-mode module 12 will now be described. Firstly, the operation of sending a data packet from the user-mode module 12 to the kernel-mode driver will be described. In order to inject a packet into the protocol stack at a specific interception point, the API 15 constructs and sends an IPv6 UDP packet whose destination address is an IPv6 link-local address uniquely associated with the host driver for purposes of inserting packets into a given packet path, i.e. either the packet transmit path or the packet receive path. Referring to FIG. 6, the driver inspects the packet stream at block 501 and, at block 502, filters out those packets that carry a destination address that matches an IPv6 address allocated to that driver. In one embodiment of the invention, the payload of the UDP packet entirely comprises the packet to be inserted into either the transmit or the receive path, disambiguated by the destination IPv6 address of the UDP tunnel header, and the interception point checks that the destination UDP port in the tunnel header is equal to the sequence number next expected from the user-mode component having the IPv6 address and port apparent in the UDP tunnel header. In a second embodiment of the invention, the payload of the UDP packet has two parts: a message header 36 followed by the representation 33 of the packet that is to be inserted. At block 504 the outer header 35 is removed and the control data field 36 is inspected. Control data field carries information which instructs the driver how to handle the packet. The payload, minus the control data field 36, if present, is used to construct a new kernel packet. The control data field 36 may indicate which interception point in that driver the packet is destined for. At block 505 this new packet is inserted into the appropriate kernel data path.

Each driver stores a list of sockets that have registered an interest in receiving packets received by the driver. The registration request can include information identifying a particular interception point within a driver. A socket registers with a driver by sending a registration request to the driver. After passing through the TCP/IP stack the request will contain the UDP source port number and the source IPv6 address of the socket 25 in headers inserted by the UDP and IP drivers, respectively. The driver extracts this information and adds a new entry, including IPv6 address, port number, expected sequence number for packets sent by the interception point to the user-mode component, expected sequence number for packet received from the user-mode component, and any filtering information (e.g. a bit-mask, subnet details etc) to a list of currently registered sockets. The sequence numbers for packets sent and received, or other flow control information, that is stored assists with in order delivery of packets between the user-mode prototype and the kernel-mode driver.

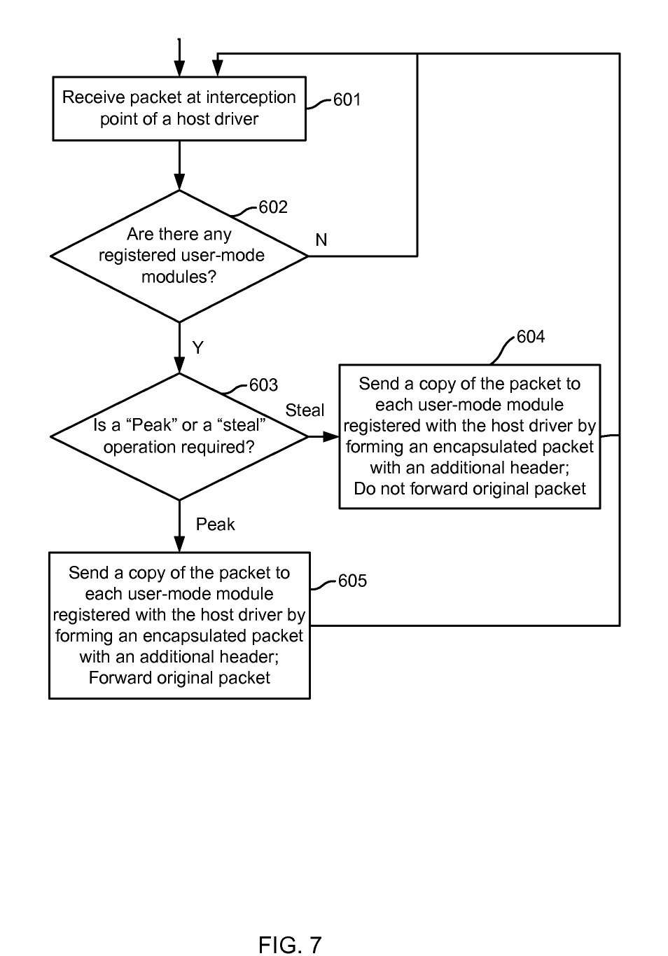

The data path from the kernel-mode host driver to the user-mode module will now be described with respect to FIG. 7. FIG. 7 shows a method performed by a host driver supporting an interception point. At block 601 a packet is received at a driver. At block 602 the driver inspects the list of registered user-mode modules or sockets. If the list is empty the method does not need to take any further action. However, if user-mode modules or sockets have registered with the driver the method proceeds to block 603. For each registered socket, the driver sends a copy of the received packet to each registered user-mode module/socket in block 604 or 605 by generating an encapsulated UDP packet for each registered socket. The source IPv6 address used in the UDP tunnel header may be used to indicate whether the packet was redirected from the transmit or receive path of the protocol stack, and the source port number in the UDP tunnel header may be set equal to the next sequence number expected by the user-mode component from the interception point. The encapsulated packet contains an image of the received data packet as a payload, and a sequence number enabling the user-mode component to detect reordering or loss of tunneled packets. The destination address and port of the socket are entered into the header of the new packet and this new packet is forwarded up the protocol stack. The driver checks at block 603 if the socket has registered for a “peak” or a “steal” operation. If a socket has registered to steal packets then the data packet is deleted by the driver at block 604. Otherwise, the original packet is allowed to continue along the usual data path through the protocol stack. This suffices to deliver images of packets appearing at the defined interception points over the sockets that have registered an interest in them. The IPv6 driver may not transmit packets towards the driver address without first completing the IPv6 Neighbor Discovery protocol for the driver IPv6 address. Therefore, the driver code inspects packets on the transmit path to identify IPv6 Neighbor Solicitation messages destined for its own address or addresses and, when one is detected, it generates the appropriate Neighbor Advertisement message and returns it up the stack. This allows the Neighbor Discovery protocol to complete and renders the driver address valid in the IPv6 driver.

Programming of the interaction between the user-mode module 12 and a host driver can be simplified by the use of an API, e.g. written in C# or a high-level language, which hides implementation details and socket semantics from the programmer. The API allows the programmer to focus on just four essential abstractions: API initialization, packet modification, packet deletion and packet creation. In addition, the API allows the programmer to assume that packet ordering is preserved and to ignore the possibility of packet loss within the protocol stack, which might otherwise occur due to multi-threading or packet pool exhaustion, by checking for these conditions and throwing an exception if it encounters either condition from which it cannot recover. In an embodiment, the API 15 is implemented as a software class encapsulating a message passing protocol layered on an IPv6 UDP socket 25, such as the .NET class that wraps a socket. This allows the implementation of the API to exploit the well-tuned and stable socket library for such purposes as buffering and I/O primitives. Use of a large socket buffer size can help to relieve pressure on the kernel packet pools that might otherwise have to deal with extra internal traffic generated this system.

Use of IPv6 to assign an IPv6 link-local address to each of the kernel-mode components is one example addressing scheme (and IPv6 addresses are plentiful and easy to obtain); however other addressing schemes could be used. Control messages are exchanged between the API socket 25 and an interception point 40 in the form of UDP packets addressed to an IPv6 address, where the message comprises a message type, upon which the structure of remainder of the header and the entire message body may depend. To enable communication between user-mode components 12 and a kernel module hosting a interception point 40, each driver is identified by one or more unique IPv6 link-local addresses, generated, according the IETF publication RFC2373 “IP Version 6 Addressing Architecture” and the IEEE publication “Guidelines for 64-bit Global Identifier (EUI-64) Registration Authority”, from the MAC address of an obsolete Ethernet chip. This address uniquely identifies the driver within a given host computer and the API sends a message to the driver by sending a UDPv6 packet over its socket with a destination address equal to that of the driver. In an embodiment, some or all of the padding bytes “FFFE” used in IEEE EUI-64 may be replaced with an index number to uniquely identify different interception points (e.g. to distinguish between different network adapters). This simplifies the address structure and reduces the overall number of addresses that need to be recognized and responded to.

In order for an interception point to send a message to an instance of the API it must know the socket address that the API is using. Therefore each instance of the API registers its socket 25 with a driver, as follows. Firstly, it selects an IPv6 address from the set of IPv6 addresses on its IPv6 adapter, opens an IPv6 UDP socket and binds it to that address. It next sends a UDP message towards the driver address comprising a control message type that signifies a registration request and a bit mask indicating a subset of the available interception points implemented in the driver. The driver caches this information and uses it to send a message whose body is an image of a packet at one of its interception points to every appropriately registered socket. Delivery of a packet image is an example of a data message, and the registration request is an example of a control message. These two classes of message are different in that data messages are atomic and require no specific acknowledgement, where a control message may require specific acknowledgement and may generate a response comprising several messages. Microsoft® Windows does not provide a managed class for making IOCTL system calls and, therefore, the new message set includes message types for issuing commands to the driver and interrogating its state so that IOCTL systems calls can be avoided and prototypes may be written as managed NET applications, obtaining the benefits of stronger program type-checking.

Aspects of the prototype will now be described. The following code gives a simple example of a prototype written in C#.

using System.Threading;
using System;
using UkpApi;
class Program
{
static uint Count = 0;

| | |
|---|---|
| static ukpapi api = new ukpapi(null,null,null,null,null, | // Note 1. |

```
        null,null,CallbackRxHiSteal,null);
  static void Main(string[ ] args)
  {
    Thread.Sleep(−1);
  }
```

| | |
|---|---|
| public static bool CallbackRxHiSteal(byte[ ] RcvBuffer, | // Note 2. |

```
                      uint MessageLength)
  {
```

| | |
|---|---|
| if (MessageLength == 7 + 74 && | // Note 3. |

```
        RcvBuffer[7+12]==0x08 && RcvBuffer[7+13]==0x00 &&
        // EthType=IPv4.
        RcvBuffer[7+23]==0x01 && // Protocol=ICMP.
        RcvBuffer[7+34]==0x08 && RcvBuffer[7+35]==0x00)
        // Type=echo, code=0.
        RcvBuffer[MessageLength−1] = 0x00;
```

| | |
|---|---|
| if (++Count % 9 == 0) | // Note 4. |
| api.PacketInjectRxHi(RcvBuffer, MessageLength); | |
| return true; | // Note 5. |
| } | |
| } | |

The example demonstrates four main primitives of the programming model. This example prototype emulates the effect of a faulty communication link by setting to zero the last byte of every seventy-four byte ICMPv4 echo packet and by duplicating every ninth packet. It achieves this by rewriting the stream of packets flowing between the wireless mesh driver (module 22) and the IP stack (module 21) on the receive path Rx.

Referring to the code example above, the first thing the program does is to create an instance of the API at the line marked Note 1. The programmer can create multiple such objects. Arguments to the constructor indicate which of the interception points are to be activated. There are two arguments corresponding to each of the interception points, referred to as peek and steal, respectively. The first provides the program with a copy of each packet without disturbing the flow of the original packet through the protocol stack. The second provides the program with a unique image of the packet while simultaneously deleting the original from the protocol stack. A null argument signifies no interest in a specific interception point, but a function pointer supplied as an argument specifies a callback routine to be invoked whenever a packet arrives at that interception point. In this case the program supplies a function pointer that will be invoked when a packet arrives at the RxHi interception point.

The callback routines are invoked sequentially by the API so that the programmer does not have to deal with concurrent execution of different callback routines or between multiple threads concurrently executing the same callback routine. The callbacks have two common signatures, for example the line marked Note 2 illustrates the simpler of the two cases. In such a case the callback function takes just two arguments: a byte array containing the image of a packet and an integer giving the number of significant bytes in the buffer. In this example the interception point requires a Control Data overhead header to be provided (36, FIG. 5), and therefore the first seven bytes of the buffer contain a fixed-length header used by the infrastructure, with the packet data always starting a constant seven bytes into the buffer. The MessageLength argument gives the number of valid bytes within the buffer, inclusive of the seven byte header, with any trailing bytes in the buffer being of undefined value. The buffer memory is allocated by the API, and will be reused for future packets in order to avoid overhead of unnecessary garbage collection. The API guarantees not to reuse the buffer until the callback has returned, but may do so immediately thereafter. Therefore, the callback must copy the buffer if its contents are required after the function returns. The clause marked Note 3 sets the last byte of every 74-byte ICMPv4 ping packet to zero. This packet length corresponds to the size of Ethernet frame generated by the ping program for an IPv4 destination address on Microsoft® Windows. An allowance is made for the header when calculating offsets into the buffer.

The callback owns the unique image of the packet at this point because the API was initialized to steal the packets supplied to the callback. The callback may modify the packet before it is presented to other modules in the protocol stack by manipulating the buffer in which it is stored. In doing so the callback takes responsibility for the validity of the packet structure, including headers, checksums and encrypted data. In this example the effect is to invalidate the ICMP checksum, causing the receiving ICMP protocol handler will drop the packet. In addition to the callbacks, the API also exposes synchronous procedures that allow a new packet to be injected into the protocol stack at a specific interception point. This is illustrated by the clause marked Note 4. The buffer memory for these calls is typically allocated by the caller, again leaving seven leading bytes for use by the API, and the API will not access the buffer again once the synchronous call completes. In the example shown, the buffer provided by the API allows reinsertion of the original packet back into the protocol stack at the interception point from which it was removed.

Finally, consider the return value from the callback at the line marked Note 5. A possible operation in steal callback routines is to reinsert the supplied packet directly back into the stack at the point from which it was taken. This will be done automatically by the API if the callback returns a value of true. Conversely, if the callback returns false, then the packet is effectively already deleted. In this example this has the side-effect of duplicating any packet that had already been reinserted by the clause marked Note 4.

The second type of call back signature will now be considered. A specific complication for multi-homed machines is that those interception points that requires a Control Data overhead header (36, FIG. 5), such as RxLo, may be receiving packets from several network adapters. This may arise where, for example, the host driver in which it is embedded is bound to both an 802.11 card and an Ethernet card. When injecting packets into the protocol stack via a multi-homed interception point it is necessary to specify which of the several adapters is to transmit the packet. Similarly, when the API invokes a callback in these circumstances, it must indicate which of several possible adapters is involved. These considerations apply to the TxLo and RxLo interception points. The signatures of routines used at this level can be augmented with an additional integer argument that uniquely identifies each bound adapter by an index into the set of adapters bound to the host driver.

Some more detailed aspects of embodiments will now be described. Certain protocols used with a protocol stack will define a maximum size for packets. For example, an IP stack 21 defines a Maximum Transmission Unit (MTU). For the case of an Ethernet adapter, the IP stack 21 would expect to generate frames of up to 1514 bytes in size, inclusive of an Ethernet header, and TCP would select its segment size accordingly. The provision of a tunneled path 30 across the IP module 21 requires a packet having a length which will be greater than that normally allowed by the IP stack 21. Consider that a packet of the maximum 1514 byte size should be sent as a payload of encapsulated packet between a socket and an interception point 40 below the IP stack 21. Additional headers will be added by the UDP and IP protocol drivers beneath the socket 25, thereby adding a further 48 bytes to the packet size on an IPv6 stack. This would lead to fragmentation of the encapsulated packet at the IP layer if a packet of the maximum size is encapsulated. A solution is for interception points 40 to advertise an inflated value of the MTU, comprising the MTU of a real network link (e.g. 1514 bytes) plus the expected encapsulation overheads. Then, for example, when TCP opens a new connection it calculates an excessive segment size and IP generates a frame whose size exceeds the MTU of the real link. Interception points 40 on the transmit path detect and reject outsized packets which are received with destinations other than the interception point itself by returning an ICMP “packet Too Big” message to the IP stack 21 indicating the MTU of the real link as to be used in future transmissions to that destination. This causes the necessary adjustments to be made. Where outsized packets are received by an interception point which are destined for the interception point itself, no ICMP “packet Too Big” message is sent because no adjustment is required.

ICMP messages may also be used in relation to deregistration of a socket that has closed. Interception points 40 deal with this condition by detecting ICMP “Port Unreachable” messages issued by a UDP driver that has been asked to deliver a packet to a port that is not open.

It is possible for UDP packets to be dropped in the protocol stack due to overload of kernel resource pools. This can happen when queues build up in a low-level driver due to congestion in the network, or when protocols with no flow control, such as UDP, generate packets faster than the protocol stack can clear them. It is much easier for the programmer to implement a prototype if they can safely assume that messages cannot be lost in the protocol stack, and similarly, that they cannot be reordered. Inclusion of sequence numbers in all messages exchanged between the API 15 and the host driver can allow detection of packet loss or reordering in either direction. The API 15 checks the sequence number of messages received from the driver, throwing an exception if loss is detected, and attempts to reorder any messages that arrive out of sequence by temporarily holding them in an internal queue. Similarly, the driver detects loss or reordering between the API and interception point, which it indicates to the API by sending it a control message. The API signals loss or unrecoverable reordering by throwing an exception, indicating whether the fault was detected at the API or at the interception point, so that the programmer need make no explicit provision for either eventuality. Sequence numbering can be independent in each direction (i.e. host driver to API and API to host driver).

Control messages sent from the API introduce some further complications. It may be necessary to associate a control message with a response message in which the driver indicates the outcome of the requested operation. It may also be necessary to provide an alternative way of detecting message loss because the API may not have any further messages to send to the driver. Finally, some control messages may generate a set of messages in response, for example to expose the contents of a large VRR routing table. The API can provide for these requirements by keeping unacknowledged control messages on a queue while blocking the thread that submitted the control message. Reply messages from the kernel indicate the sequence number of the requesting message, and the number of packets making up the response, so that the API can determine when to release the requesting thread. The API throws an exception on a blocked thread if a complete reply is not received within a defined time.

In order to handle high packet rates it is helpful for the API to be efficient both in its use of socket operations and its use of buffers. To avoid unnecessary and expensive allocation and garbage collection of data buffers, the API allocates a pool of packet buffers during its initialization and uses these as the destination of all socket read operations. The size of this pool determines the number of out-of-order packets that the API can reorder before presenting them to the prototype.

To accommodate a situation where the network stack below the interception point becomes congested, a flow control technique may be used which uses the sequence numbering of packets (as described above in relation to packet loss and packet reordering). A limit may be set for the number of packets sent by the prototype that may be awaiting an acknowledgement from the intended recipient of the packet in the network.

The API uses socket asynchronous ReceiveFrom and Transmit operations to provide the prototype with efficient I/O. The asynchronous read completion routine checks that packet ordering is preserved, placing out-of-order packets on a reorder queue, and invokes a message switch to synchronously enter one of the prototype call back routines. The API guarantees to serialize all calls to the prototypes call back routines in order that the programmer need not write concurrent code. In an example, where there are three packets to be processed by a prototype, one may be given to a call back routine with the other two retained by the API and with the second packet being given to a call back routine when the first packet is returned, etc. Buffers returned by a call-back for reinsertion into the protocol stack are placed on an asynchronous transmit queue which is allowed to clear ahead of any synchronous requests from the prototype to insert a new packet; this allows the transmission routines to apply sequence numbering to the packets for validation by the driver.

A restriction may be imposed that at most one prototype at a time may register with a given interception point to steal packets. This prevents the same packet from being stolen by multiple prototypes concurrently and then several processed versions of the packet being inserted into the protocol stack at the interception point (or a different one).

As described earlier, the API 25 allows the programmer to supply a number of function pointers (“delegates”) when constructing an instance of the class that implements the API. The constructor takes two function pointers for each interception point supported by the API: one is used to inspect packets and the other to take control of packets. The API 25 creates and registers a socket according to the function pointers with which it was supplied and calls the appropriate function pointer in the user's program when a packet is received over the socket. In the simplest case it passes the function just two arguments: a byte array containing the packet and an integer giving the number of valid bytes in the array. Where the interception point 40 is multiplexing packets from several network adapters it may supply a third argument to uniquely identify that adapter. In order for the user's function to reinsert a packet back into the stack at the point from which it was removed the function only has to return the appropriate Boolean value and the API will do the rest. In addition, the API allows the programmer to forget about issues of potential packet reordering or loss, for example due to multi-threading or packet pool exhaustion, by using sequence numbers on exchanges between itself and the interception points and by throwing an exception if it encounters a condition from which it cannot recover. In cases where interception points have been embedded in an existing driver it may be convenient to extend the API to include primitives for interrogating and updating the state of the driver so that the prototype is provided with an integrated API for controlling the operation of the driver and the flow of packets through it.

Where there is more than one adapter below the interception point in the protocol stack, e.g. a WiFi adapter and an Ethernet adapter, and a packet going up the protocol stack (in the Rx path) is stolen, then either the source IPv6 address used in the UDP tunnel header (e.g. using EUI-64 padding bytes) or the Control Data overhead header (36, FIG. 5) identifies which adapter the packet was received from. Similarly, where a packet is injected into the Tx path, the information provided to the interception point by the prototype includes an indication of which adapter the injected packet should be sent to either in the destination IPv6 address of the UDP tunnel header or in the Control Data overhead header (36. FIG. 5). Where there are multiple protocols above an interception point, e.g. an IPv4 and an IPv6 protocol module, any packet injected which is going up the protocol stack (in the Rx path) may be duplicated and sent to both protocols. In the IPv4, IPv6 example, only one of the Layer 3 modules will accept the packet and the other will reject it.

Whilst in the above examples, UDP is used between the API and the interception point, in other examples, different protocols may be used. In some examples, the API may support fragmentation (e.g. where the MTU of a network interface card is much bigger than the supported tunnel size of the transport between the API and the interception point).

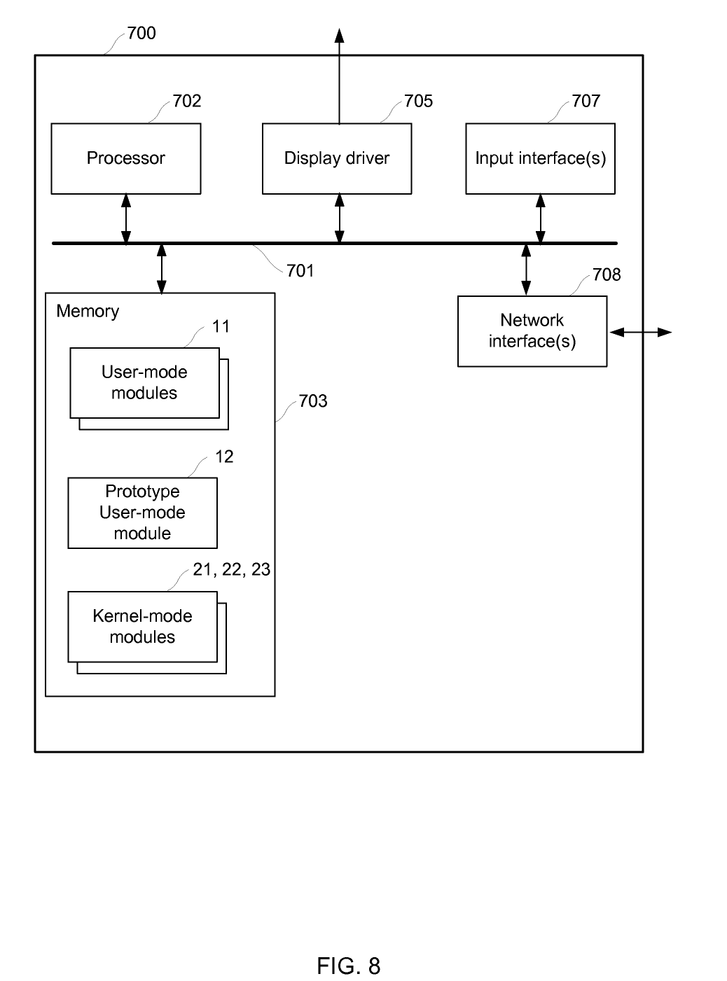

FIG. 8 illustrates various components of an exemplary computing-based device 700 which may be implemented as any form of a computing and/or electronic device, and in which embodiments of the system and methods described above may be implemented.

Computing-based device 700 comprises one or more processors 702 which may be microprocessors, controllers or any other suitable type of processors for processing computing executable instructions to control the operation of the device. The processor 702 is connected to other components of the device via one or more buses 701. As described previously, the processor executes software comprising kernel-mode modules 21, 22, 23 which can form an operating system and/or a protocol stack for processing packets. The processor also executes software comprising user-mode modules 11 and a user-mode prototype module which have typically written in a higher-level language than the kernel-mode modules.

The computer executable instructions may be provided using any computer-readable media, such as memory 703. The memory is of any suitable type such as random access memory (RAM), a disk storage device of any type such as a magnetic or optical storage device, a hard disk drive, or a CD, DVD or other disc drive. Flash memory, EPROM or EEPROM may also be used.

The computing-based device 700 comprises one or more network interface inputs, which can be of any suitable type for receiving media content, Internet Protocol (IP) input, etc. In embodiments of the system described above, packets may be received over a Layer 2 (Ethernet, wireless Ethernet) interface.

The computing device 700 can also comprise one or more input interfaces 707 for receiving input from a user.

An output is also provided such as an audio and/or video output from a display driver 705 to a display system integral with, or in communication with, the computing-based device. The display system may provide a graphical user interface, or other user interface of any suitable type although this is not essential.

Although the above description refers to the interception points being located within a kernel-mode module, in some examples the interception point may be located within a user-mode module, e.g. where part of the protocol (or data processing) stack is implemented in user-mode. An example of this is the Windows Sockets interface, where there is already an interface defined for the interception TDI, or Layered Service Providers.

Embodiments of the methods described above enable user-mode programs to insert new packets, or to inspect, modify and delete existing packets from one or more points in either or both of the transmit and receive paths of the kernel-mode protocol stack. Embodiments of the methods run alongside existing network protocol software, such as that distributed commercially with the Microsoft Windows operating system, without requiring any modification thereto and embodiments support prototypes written in modern programming environments using strongly typed, garbage-collected languages such those as supported by the Microsoft .NET framework running as fully managed code. Embodiments of the methods described provide a user-mode programming environment that simplifies the task of writing a prototype by eliminating concurrency, presenting packets as managed code byte arrays and detecting loss and reordering of packets within the rewritten packet stream. Embodiments require only conventional UDP sockets of type SOCK_DGRAM without the need for any modification or extension to commercially-available socket libraries and the methods may be applied at one or more points in the kernel-mode protocol stack below the level of the Internet Protocol (IP) protocol driver.

Embodiments of the methods described above employ packet tunneling techniques, conventionally used for encapsulating network packets during transit between distinct computers in a network, typically in order to control their route through the network or so that an entire packet can be encrypted, for examples see the IETF standards RFC2406 and RFC2473. The techniques described above make innovative use of packet tunneling to reroute packets, not between the protocol stacks of different computers but within the protocol stack of a single computer, firstly in order to expose the stream of packets flowing through the kernel-mode part of the protocol stack to a user-mode program, and secondly in order that the user-mode program is able to insert a stream of packets into the kernel-mode part of the protocol stack.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a tangible storage medium. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual steps may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method steps or elements identified, but that such steps or elements do not comprise an exclusive list and a method or apparatus may contain additional steps or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. One or more tangible device-readable media with device-executable instructions for performing steps comprising:
defining at least a first interception point in a kernel-mode module which forms part of a data path for packets;
intercepting a first packet at the first interception point;
sending an intercepted packet to a user-mode module, said intercepted packet comprising one of the first packet and a copy of the first packet;
receiving, at an interception point in the data path, the intercepted packet after processing by the user-mode module;
inserting the received packet into the data path.

2. One or more tangible device-readable media according to claim 1, wherein the device-executable instructions define a first interception point and a second interception point which are at different positions in the data path.

3. One or more tangible device-readable media according to claim 1, wherein the step of inserting the received packet into the data path occurs at the second insertion point.

4. One or more tangible device-readable media according to claim 2 wherein the first interception point and the second interception point are at opposite sides of the same kernel-mode module.

5. One or more tangible device-readable media according to claim 2 wherein at least one of the first interception point and the second interception point is defined as part of a shim module positioned between kernel-mode modules in the data path.

6. One or more tangible device-readable media according to claim 1, further comprising device-executable instructions for performing a step comprising:
removing the first packet from the data path when sending the intercepted packet to a user-mode module.

7. One or more tangible device-readable media according to claim 1, wherein the kernel-mode module forms part of a protocol stack and wherein the steps of sending the intercepted packet to a user-mode module and receiving the intercepted packet from a user-mode module use packet tunneling within the protocol stack.

8. One or more tangible device-readable media according to claim 1, wherein the step of receiving the intercepted packet from the user-mode module comprises receiving the intercepted packet as a payload of an encapsulated packet having overhead information comprising an address of the kernel-mode module hosting the interception point.

9. One or more tangible device-readable media according to claim 8, wherein the data path restricts packets to a maximum size limit and the device-executable instructions further perform a step of:
advertising an increased maximum size limit which is set at a value at least equal to an intercepted packet of an existing maximum size limit plus the overhead information.

10. One or more tangible device-readable media according to claim 1, further comprising device-executable instructions for performing a step comprising:
including control information when sending the intercepted packet to a user-mode module.

11. One or more tangible device-readable media according to claim 10, wherein the control information comprises at least one of:
sequence numbering information;
information identifying an adapter which is the origination of, or destination of, the packet.

12. One or more tangible device-readable media according to claim 1 wherein control information associated with an intercepted packet is encoded using at least one of: a destination IP address, a source IP address, a port number and a padding byte.

13. One or more tangible device-readable media according to claim 12, wherein sending an intercepted packet to a user-mode module comprises:
selecting a destination address for the intercepted packet, the destination address identifying at least one of: the first interception point, the data path and a sequence number of the packet.

14. One or more tangible device-readable media according to claim 1 further comprising device-executable instructions for performing steps comprising:
receiving the intercepted packet at a user-mode module;
selecting a form of processing for the intercepted packet, wherein the processing is selected from at least one of:
sending the packet unmodified to the first interception point;
sending the packet unmodified to a different interception point;
modifying the packet and sending the packet to the first interception point; and
modifying the packet and sending the packet to a different interception point.

15. One or more tangible device-readable media according to claim 1 further comprising device-executable instructions for performing steps comprising:
receiving, at an interception point in the data path, a packet which has been newly created by the user-mode module;
inserting the received packet into the data path.

16. One or more tangible device-readable media according to claim 1, wherein the step of sending the intercepted packet to a user-mode module comprises sending the intercepted packet to a socket which has an application programming interface between the socket and the user-mode module.

17. One or more tangible device-readable media according to claim 16, wherein the application programming interface has a restricted set of commands comprising:
registering with an interception point;
creating a packet;
modifying a packet;
deleting a packet.

18. One or more tangible device-readable media with device-executable instructions for implementing a user-mode module in a system also comprising a set of kernel-mode modules which form a data path for packets, the device-executable instructions performing steps comprising:
receiving a packet, the received packet comprising one of a packet which has been intercepted by a first interception point in one of the kernel-mode modules and a copy of said packet;
selecting a form of processing for the received packet, wherein the processing is selected from at least one of:
sending the packet unmodified to the first interception point;
sending the packet unmodified to a different interception point;
modifying the packet and sending the packet to the first interception point; and
modifying the packet and sending the packet to a different interception point.

19. One or more tangible device-readable media according to claim 18, further comprising device-executable instructions for performing steps comprising:
creating a new packet;
sending the new packet to an interception point in the data path for insertion into the data path.

20. A method of prototyping a kernel-mode program module in software comprising a set of kernel-mode program modules and at least one user-mode program module, the set of kernel-mode program modules forming a protocol stack with a data path, the method comprising:
creating a prototype user-mode program module having functionality which is to be prototyped;
adding at least a first interception point and a second interception point at different positions along the data path through the protocol stack;
forwarding, from the first interception point to the prototype user-mode program module, packets intercepted in the data path;
processing forwarded packets at the prototype user-mode program module to form processed packets;
returning processed packets to the second interception point; and
inserting the processed packets into the data path at the second interception point.
